(19) United States
(12) Patent Application Publication
(10) Pub. No.: US 2021/0056537 A1
(43) Pub. Date: Feb. 25, 2021

(54) A Dummy Card Based Transaction Processing System and Method Thereof

(71) Applicant: Mandar AGASHE, Pune - Maharashtra (IN)

(72) Inventor: Mandar AGASHE, Pune - Maharashtra (IN)

(21) Appl. No.: 16/960,167

(22) PCT Filed: Jan. 5, 2019
(86) PCT No.: PCT/IB2019/050082

§ 371 Date: Jul. 6, 2020

(30) Foreign Application Priority Data
Jan. 6, 2018 (IN) 20181000690

(51) Int. Cl. G06Q 20/34; G06Q 20/38; G06Q 20/36; G06Q 20/40

(52) U.S. Cl. CPC G06Q 20/351; G06Q 20/385; G06Q 20/40145; G06Q 20/3821; G06Q 20/363

(57) ABSTRACT

The present disclosure relates to the field of payment systems and provides a dummy card based transaction processing system and method. The system is used for facilitating payment transactions between a plurality of users. Each user is associated with a dummy card having a unique dummy card number issued by a financial entity. The system (100) comprises a plurality of user devices (10) and a dummy card server (101). Each user device (10) is associated with a user having a financial account in a financial institution. The financial account is linked to a registered mobile number of the user. The dummy card sewer (101) is configured to facilitate a registered user to link all his debit, credit, and prepaid cards with the dummy card and carry out payment transactions using the unique dummy card number.

### FIELD

The present disclosure relates to the field of payment systems. More particularly, the present disclosure relates to a dummy card based transaction processing system and method.

### DEFINITIONS

As used in the present disclosure, the following terms are generally intended to have the meaning as set forth below, except to the extent that the context in which they are used indicate otherwise.

User device—The term “user device” hereinafter refers to a mobile phone, laptop, a tablet, a desktop, an iPad, a PDA, a notebook, a net book, and a tablet.

Device identification indicia—The term “device identification indicia” hereinafter refers to an International Mobile Station Equipment Identity (IMEI), an International Mobile Subscriber Identity (IMSI), a digital certificate, a mobile number, an encryption key and a combination thereof, which uniquely identifies the device.

Financial account—The term “Financial account” hereinafter refers to a bank account, a financial repository account, a vault account, a credit union account, an investment firm account, a repository account, and a PayPal account.

Dummy card—The term “dummy card” hereinafter refers to a plastic card issued by a financial institution to a user, which enables a user to carry out monetary transactions without carrying multiple electronic cards.

Electronic card—The term “electronic card” hereinafter refers to a a prepaid card, an electronic wallet, a debit card, and credit card.

Financial institution—The expression ‘financial institution’ used hereinafter in the specification refers to a bank, a financial repository, a vaults, a credit union, an investment firm, an account repository, and an online money transfer financial organization.

### BACKGROUND

The background information herein below relates to the present disclosure but is not necessarily prior art.

Electronic cards issued by financial institutions are commonly used for carrying out payment transactions. These electronic cards are plastic cards that enable a user to carry out transactions without carrying cash. The electronic cards provide remote access to a user to his/her financial account(s) whenever or wherever required. However, a user needs to carry his/her electronic cards at all the times to avail the above-mentioned benefits, making it difficult to keep a track of all the electronic cards physically. Moreover, if an electronic card is lost, the card details may be fraudulently used to carry out theft or unwanted transactions.

Further, the existing Point of Sale (POS) terminals or merchant terminals are designed to accept cards from customers without requiring any validation by the merchant or staff members. In addition, terminals that are not validated can give rise to high fraud levels if compromised, making it difficult to keep them secure when not being used.

Therefore, there is felt a need to provide a dummy card based transaction processing system that facilitates the users to carry out transactions without revealing their financial account details and allows them to consolidate multiple electronic cards into one card.

### OBJECTS

Some of the objects of the present disclosure, which at least one embodiment herein satisfies, are as follows:

An object of the present disclosure is to provide a dummy card based transaction processing system.

Another object of the present disclosure to provide a dummy card based transaction processing system that allows users to consolidate multiple electronic cards into one card.

Still another object of the present disclosure to provide a dummy card based transaction processing system that facilitates transactions without revealing the financial account details.

Yet another object of the present disclosure is to provide a dummy card based transaction processing system that is reliable.

Still another object of the present disclosure is to provide a dummy card based transaction processing system that reduces the possibility of misusing the card details.

Yet another object of the present disclosure is to provide a dummy card based transaction processing system that prevents the occurrence of fraud transactions in real-time.

Still another object of the present disclosure is to provide a dummy card based transaction processing system that is user friendly.

Other objects and advantages of the present disclosure will be more apparent from the following description, which is not intended to limit the scope of the present disclosure.

### SUMMARY

The present disclosure envisages a dummy card based transaction processing system and method. The dummy card based transaction processing system is used for facilitating payment transactions between a plurality of users. Each user is associated with a dummy card having a unique dummy card number issued by a financial entity. The system comprises a plurality of user devices and a dummy card server. Each of the user devices is associated with a user having a financial account in a financial institution. The financial account is linked to a registered mobile number of the user. The dummy card server is configured to facilitate registration of the users by storing their personal data, dummy card number, and electronic card information into a database, and is further configured to facilitate the registered users to make payment to or receive payment from other registered users by using their unique dummy card number.

In an embodiment, the personal data of a user includes user's name, biometric data, device identification indicia, and identification details.

In an embodiment, the database comprises:
1. a first lookup table having a list of registered users, dummy card number corresponding to each of the registered users, and registered mobile number associated with each of the registered users; and
2. a second lookup table having a list of registered users, information relating to electronic cards of each of the registered users, and dummy card number associated with each of the registered users.

In an embodiment, the dummy card server comprises a registration module, a memory, a login module, an updater, a linking module, and an assigning module. The registration module comprises an input module configured to receive a user's personal data, dummy card number, and electronic card information, and further configured to facilitate registration of the user by storing the personal data, dummy card number, and electronic card information in the form of the lookup tables in the database. The input module is further configured to generate login credentials i.e. user ID and password for the user and store the login credentials corresponding to each of the registered users in the form of a third lookup table in the database. The registration module further comprises a profile creating module configured to create a user profile based on the received personal data.

In an embodiment, the memory is configured to store a pre-determined set of processing rules. The login module is configured to facilitate a registered user to login to the dummy card server by receiving and verifying the user's login credentials with the help of the third lookup table. The updater is configured to facilitate the user to update the stored information after logging into the dummy card server using the login module. The linking module is configured to receive information associated with at least one electronic card issued by the financial institution of the user from the registration module, and is further configured to facilitate the user to link the electronic card with the unique dummy card number. The assigning module is configured to facilitate the user to assign a unique number to each of the linked electronic cards.

In an embodiment, the registration module, the login module, the updater, the linking module, and the assigning module are implemented using one or more processors.

In an embodiment, the dummy card is a plastic card having the dummy card number in an encoded form.

In an embodiment, the dummy card server further includes a first communication module, a call handling unit, a payment request generating module, a selection module, a mapping unit, and a second communication module. The first communication module is configured to receive a dummy card number when the dummy card associated with the dummy card number is swiped by a user at a merchant's Point of Sale (POS) terminal to initiate a payment transaction. The call handling unit is configured to receive an authentication call from the financial entity i.e. the dummy card issuer to authenticate the user who swiped the dummy card based on the pre-determined set of processing rules.

In an embodiment, the call handling unit comprises a crawler and extractor unit configured to crawl through the first lookup table to extract the registered mobile number of the user based on the received dummy card number. The call handling unit further comprises an authentication module configured to receive the authentication call and further configured to send a payment approval request on the extracted registered mobile number of the user. In an embodiment, the authentication module is configured to facilitate the user to enter 0 or 1 to approve or reject the payment transaction respectively.

The payment request generating module is configured to cooperate with the authentication module to generate a payment request after the user approves the payment transaction. The selection module is configured to facilitate the user to enter the assigned unique number to select a card from the plurality of cards linked with the dummy card number for carrying out the payment transaction. The mapping unit is configured to cooperate with the payment request generating module to receive the payment request, and is further configured to map the payment request with the dummy card number. The mapping unit is configured to cooperate with the selection module to replace the dummy card number with the selected electronic card of the user. The second communication module is configured to receive the selected electronic card, and is further configured to send details of the selected electronic card to the user's financial institution for carrying out the payment transaction.

In an embodiment, the call handling unit, the payment request generating module, the selection module, and the mapping unit are implemented using one or more processors.

The present disclosure also envisages a dummy card based transaction processing method for facilitating payment transactions between a plurality of users, wherein each user is defined by a unique dummy card number associated with the dummy card issued by a financial entity. The method is implemented using the system described above and comprises the following steps:
1. providing, a dummy card server, having a database and processing capability;
2. enabling, the dummy card server, to communicate with a plurality of user devices via a communication network, wherein each user device is associated with a user having a financial account in a financial institution, the financial account being linked to a registered mobile number of the user;
3. enabling, the dummy card server, to register a plurality of users by receiving their personal data, dummy card number, and electronic card information and facilitate the registered users to make payment to or receive payment from other registered users by using their unique dummy card number, the step of registering further comprising the sub-steps of:
   a. storing a first lookup table having a list of registered users, dummy card number corresponding to each of the registered users, and registered mobile number associated with each of the registered users; and
   b. storing a second lookup table having a list of registered users, information relating to the electronic cards of each of the registered users, and dummy card number associated with each of the registered users.
In an embodiment, the step of facilitating the registered users to make or receive payments comprises the following sub-steps:
   a. generating, by an input module, login credentials i.e. user ID and password, for the user and storing the login credentials corresponding to each of the registered users in the form of a third lookup table in the database;
   b. creating, by a profile creating module, a user profile based on the received personal data;
   c. facilitating, by a login module, a registered user to login to the dummy card server by receiving and verifying the user's login credentials with the help of the third lookup table;
   d. facilitating, by an updater, a registered user, to update the stored information after logging into the server using the login module.
   e. facilitating, by a linking module, a registered user to link information of at least one card associated with the user with the unique dummy card number; and
   f. facilitating, by an assigning module, a registered user, to assign a unique number to each of the linked electronic cards.
   g. receiving, by a first communication module, a dummy card number when the dummy card associated with the dummy card number is swiped by a user at a merchant's POS terminal to initiate a payment transaction;
   h. receiving, into a call handling unit, a call from the financial entity i.e. the dummy card issuer to authenticate the user who swiped the dummy card, the step of authenticating comprising the following sub-steps:
      i. extracting, by a crawler and extractor unit, the registered mobile number of the user from the second lookup table based on the user's received dummy card number; and
      ii. sending, by an authentication module, a payment approval request on the extracted registered mobile number of the user upon receiving the authentication call, and facilitating the user to enter 0 or 1 to approve or reject the payment transaction respectively,
   i. generating a payment request, by a payment request generating module, after the user approves the payment transaction;
   j. facilitating, by a selection module, the user to enter the assigned unique number to select a card from the plurality of cards linked with the dummy card number for carrying out the payment transaction;
   k. mapping, by a mapping unit, the payment request with the dummy card number, and replacing, the dummy card number with the selected electronic card of the user; and
   l. sending, by a second communication module, details of the selected electronic card to the user's financial institution for carrying out the payment transaction.

In an embodiment, the step of authenticating includes receiving a login credential inputted by the user, and authenticating the user by comparing the inputted login credential with the login credential stored in the third lookup table of the database. In another embodiment, the step of authenticating includes generating and sending a One Time Password (OTP) on the registered mobile number of the user, and facilitating the user to enter the OTP to perform authentication by comparing the inputted OTP of the user with the OTP generated and sent by the authentication module. In still another embodiment, the step of authenticating includes the facilitating the user to input his/her biometrics and comparing the inputted biometrics with the user's biometrics stored in the database.

### BRIEF DESCRIPTION OF THE ACCOMPANYING DRAWING

A dummy card based transaction processing system and method thereof will now be described with reference to the non-limiting, accompanying drawing, in which:

FIG. 1 illustrates a schematic block diagram of a dummy card based transaction processing system.

FIG. 2 illustrates a flow diagram showing steps performed by the system of FIG. 1 for effecting payment from one user to another.

### LIST OF REFERENCE NUMERALS USED IN DETAILED DESCRIPTION AND DRAWING

100—System

10—User devices

20—Merchant's POS terminal

40—Communication network

30—Database

102—Dummy card server

102—Memory

104—Login module

106—Registration module

106a—Input module

106b—Profile creating module

108—Updater

110—Linking module

112—Assigning module

114—First communication module

116—Call handling unit

116a—Crawler and extractor unit

116b—Authentication module

118—Payment request generating module

120—Selection module

122—Mapping unit

124—Second communication module

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

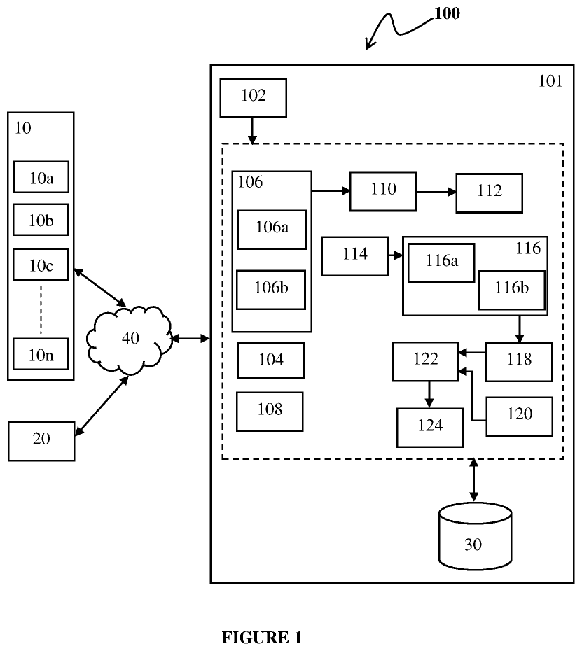

A dummy card based transaction processing system (hereinafter referred as “system 100”), of the present disclosure, is now being described with reference to FIG. 1.

The dummy card based transaction processing system (100) is used for facilitating payment transactions between a plurality of users. Each user is associated with a dummy card having a unique dummy card number issued by a financial entity. Referring to FIG. 1, the system (100) comprises a plurality of user devices (10) and a dummy card server (101). Each of the user devices (10) is associated with a user having a financial account in a financial institution. The financial account is linked to a registered mobile number of the user. The dummy card server (101) is configured to facilitate registration of the users by storing their personal data, dummy card number, and electronic card information into a database (30), and is further configured to facilitate the registered users to make payment to or receive payment from other registered users by using their unique dummy card number.

In an embodiment, the personal data of a user includes user's name, biometric data, device identification indicia, and identification details.

In an embodiment, the database (30) comprises:
3. a first lookup table having a list of registered users, dummy card number corresponding to each of the registered users, and registered mobile number associated with each of the registered users; and
4. a second lookup table having a list of registered users, information relating to electronic cards of each of the registered users, and dummy card number associated with each of the registered users.

In an embodiment, the dummy card server (101) comprises a registration module (106), a memory (102), a login module (104), an updater (108), a linking module (110), and an assigning module (112). The registration module (106) comprises an input module (106a) configured to receive a user's personal data, dummy card number, and electronic card information, and further configured to facilitate registration of the user by storing the personal data, dummy card number, and electronic card information in the form of the lookup tables in the database (30). The input module (106a) is further configured to generate login credentials i.e. user ID and password for the user and store the login credentials corresponding to each of the registered users in the form of a third lookup table in the database (30). The registration module (106) further comprises a profile creating module (106b) configured to create a user profile based on the received personal data.

In an embodiment, the memory (102) is configured to store a pre-determined set of processing rules. The memory (102) may include any computer-readable medium known in the art, including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes, and/or a cloud based storage (cloud storage). The login module (104) is configured to facilitate a registered user to login to the dummy card server (101) by receiving and verifying the user's login credentials with the help of the third lookup table. The updater (108) is configured to facilitate the user to update the stored information after logging into the dummy card server (101) using the login module. The linking module (110) is configured to receive information associated with at least one electronic card issued by the financial institution of the user from the registration module (106), and is further configured to facilitate the user to link the electronic card with the unique dummy card number. The assigning module (112) is configured to facilitate the user to assign a unique number to each of the linked electronic cards.

In an embodiment, the registration module (106), the login module (104), the updater (108), the linking module (110), and the assigning module (112) are implemented using one or more processors.

In an embodiment, the dummy card is a physical plastic card having the dummy card number in an encoded form. In another embodiment, the dummy card is in an electronic form and stored in a user device (10).

In an embodiment, the dummy card server (101) further includes a first communication module (114), a call handling unit (116), a payment request generating module (118), a selection module (120), a mapping unit (122), and a second communication module (124). The first communication module (114) is configured to receive a dummy card number when the dummy card associated with the dummy card number is swiped by a user at a merchant's POS terminal (20) to initiate a payment transaction. In an embodiment, the payment transaction is initiated by entering the dummy card number on the merchant's e-commerce website. In still another embodiment, the payment transaction is initiated by inserting the dummy card number in an Automated Teller Machine (ATM). The call handling unit (116) is configured to receive an authentication call from the financial entity i.e. the dummy card issuer to authenticate the user who swiped the dummy card based on the pre-determined set of processing rules.

In an embodiment, the call handling unit (116) comprises a crawler and extractor unit (116a) configured to crawl through the first lookup table to extract the registered mobile number of the user based on the received dummy card number. The call handling unit (116) further comprises an authentication module (116b) configured to receive the authentication call and further configured to send a payment approval request on the extracted registered mobile number of the user.

In an embodiment, the authentication module (116b) is configured to facilitate the user to enter 0 or 1 to approve or reject the payment transaction respectively. In an embodiment, the authentication module (116b) is configured to provide biometric authentication (e.g. voice recognition) of the user.

In an embodiment, if the user is unable to receive the payment approval request from the dummy card issuer, the system (100) may be configured to facilitate the user to set reject or accept the payment approval request by default on his/her user device (10) or allow the transaction as per pre-defined velocity rule, for example, the user may set a specific limit on transaction amount or number of transactions per day.

In another embodiment, the authentication module (116b) is configured to receive a login credential inputted by the user, and is further configured to authenticate the user by comparing the inputted login credential with the login credential stored in the third lookup table of the database (30). In still another embodiment, the authentication module (116b) is configured to generate and send a One Time Password (OTP) on the registered mobile number of the user, and is further configured to facilitate the user to enter the OTP to perform authentication by comparing the inputted OTP with the OTP generated and sent by the authentication module. In yet another embodiment, the authentication module (116b) is configured to authenticate a user by facilitating the user to input his/her biometrics and comparing the inputted biometrics with the user's biometrics stored in the database (30).

In one embodiment, the dummy card can also be used at the merchant side with a fixed PIN/password provided by the dummy card issuer. When the dummy card is used, the authentication module (116b) receives a call from the dummy card issuer to authenticate the user. The authentication module (116b) sends a payment approval request on the registered mobile number of the user to enable the user to authorize the transaction by entering the PIN/password.

The payment request generating module (118) is configured to cooperate with the authentication module to generate a payment request after the user approves the payment transaction. The selection module (120) is configured to facilitate the user to enter the assigned unique number to select a card from the plurality of cards linked with the dummy card number for carrying out the payment transaction. The mapping unit (122) is configured to cooperate with the payment request generating module to receive the payment request, and is further configured to map the payment request with the dummy card number. The mapping unit (122) is configured to cooperate with the selection module (120) to replace the dummy card number with the selected electronic card of the user. The second communication module (124) is configured to receive the selected electronic card, and is further configured to send details of the selected electronic card to the user's financial institution for carrying out the payment transaction.

In an embodiment, the call handling unit (116), the payment request generating module (118), the selection module (120), and the mapping unit (122) are implemented using one or more processors.

In an exemplary embodiment, a customer gets a dummy card from a financial entity designated as dummy card issuer. The customer registers the dummy card with the system (100) of the present disclosure and links all the credit cards, debit cards, and prepaid cards with the dummy card. The customer also links his/her mobile number and/or email account with the dummy card. For initiating a transaction with a merchant, the customer gives the dummy card to the merchant. The merchant swipes or dips the dummy card at his/her POS terminal. At this point, the customer receives a payment approval request via an IVR system on his/her registered mobile. The customer enters 1 to accept and 0 or to reject the payment transaction. If the customer accepts the payment transaction, the system (100) replaces the dummy card with one of the actual linked cards of the customer and sends it to the financial institution of the customer to complete the transaction.

In an alternate embodiment, for initiating a person to person payment transaction, a first user (i.e. the payee or receiver of funds) generates a unique PIN/number using the system (100) and gets the unique PIN/number on his/her user device (10) via text message or Interactive voice response (IVR). The first user then shares the unique PIN/number with the second user (i.e. the payer or sender of funds). The second user uses IVR to enter his dummy card server login credentials, first user's PIN/number, and the amount to be transacted to initiate the payment transaction. The system (100) extracts the first and second user's account/debit card number details from the database and replaces the PIN/number with the extracted actual bank account/debit card number details for transferring the funds.

The present disclosure also envisages a dummy card based transaction processing method for facilitating payment transactions between a plurality of users, wherein each user is defined by a unique dummy card number associated with the dummy card issued by a financial entity. The method is implemented using the system (100) described above and comprises the following steps:
1. providing, a dummy card server (101), having a database (30) and processing capability;
2. enabling, the dummy card server (101), to communicate with a plurality of user devices (10) via a communication network (40), wherein each user device (10) is associated with a user having a financial account in a financial institution, the financial account being linked to a registered mobile number of the user, said communication network (40) is selected from the Internet, a wireless network, or a wired network;
3. enabling, the dummy card server (101), to register a plurality of users by receiving their personal data, dummy card number, and electronic card information and facilitate the registered users to make payment to or receive payment from other registered users by using their unique dummy card number, the step of registering further comprising the sub-steps of:
   a. storing a first lookup table having a list of registered users, dummy card number corresponding to each of the registered users, and registered mobile number associated with each of the registered users; and
   b. storing a second lookup table having a list of registered users, information relating to the electronic cards of each of the registered users, and dummy card number associated with each of the registered users.

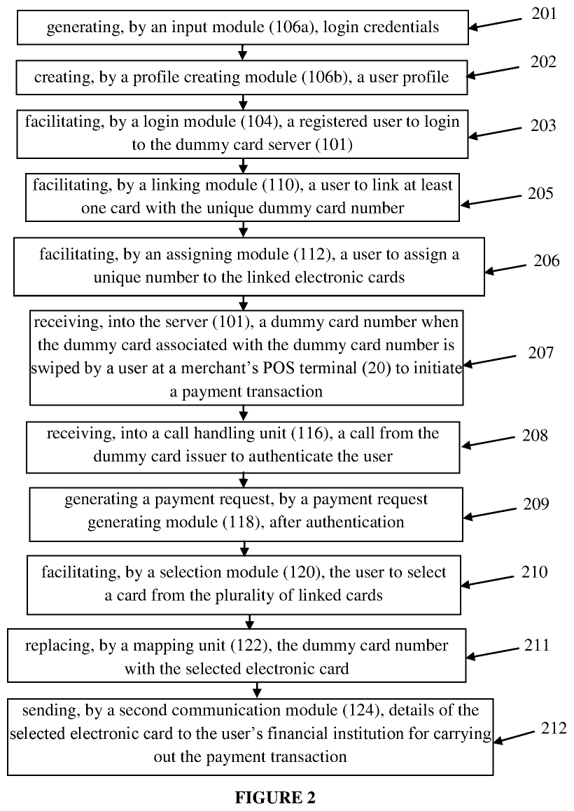

Referring to FIG. 2, the step of facilitating the registered users to make or receive payments comprises the following sub-steps:
Step 201—generating, by an input module (106a), login credentials i.e. user ID and password, for the user and storing the login credentials corresponding to each of the registered users in the form of a third lookup table in the database (30);
Step 202—creating, by a profile creating module (106b), a user profile based on the received personal data;
Step 203—facilitating, by a login module (104), a registered user to login to the dummy card server (101) by receiving and verifying the user's login credentials with the help of the third lookup table;
Step 204—facilitating, by an updater (108), a registered user, to update the stored information after logging into the server (101) using the login module;
Step 205—facilitating, by a linking module (110), a registered user to link information of at least one card associated with the user with the unique dummy card number;
Step 206—facilitating, by an assigning module (112), a registered user, to assign a unique number to each of the linked electronic cards;
Step 207—receiving, by a first communication module (114), a dummy card number when the dummy card associated with the dummy card number is swiped by a user at a merchant's POS terminal (20) to initiate a payment transaction;
Step 208—receiving, into a call handling unit (116), a call from the financial entity i.e. the dummy card issuer to authenticate the user who swiped the dummy card, the step of authenticating comprising the following sub-steps:
   i. extracting, by a crawler and extractor unit (116a), the registered mobile number of the user from the second lookup table based on the user's received dummy card number; and
   ii. sending, by an authentication module (116b), a payment approval request on the extracted registered mobile number of the user upon receiving the call, and facilitating the user to enter 0 or 1 to approve or reject the payment transaction respectively,
Step 209—generating a payment request, by a payment request generating module (118), after the user approves the payment transaction;
Step 210—facilitating, by a selection module (120), the user to enter the assigned unique number to select a card from the plurality of cards linked with the dummy card number for carrying out the payment transaction;
Step 211—mapping, by a mapping unit (122), the payment request with the dummy card number, and replacing, the dummy card number with the selected electronic card of the user; and
Step 212—sending, by a second communication module (124), details of the selected electronic card to the user's financial institution for carrying out the payment transaction.

In an embodiment, the step of authenticating includes receiving a login credential inputted by the user, and authenticating the user by comparing the inputted login credential with the login credential stored in the third lookup table of the database (30). In another embodiment, the step of authenticating includes generating and sending a One Time Password (OTP) on the registered mobile number of the user, and facilitating the user to enter the OTP to perform authentication by comparing the inputted OTP of the user with the OTP generated and sent by the authentication module. In still another embodiment, the step of authenticating includes the facilitating the user to input his/her biometrics and comparing the inputted biometrics with the user's biometrics stored in the database (30).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

Technical Advancements

The present disclosure described herein above has several technical advantages including, but not limited to, the realization of a dummy card based transaction processing system and method thereof, that:
allows users to consolidate multiple electronic cards into one card;
allows transactions without having to reveal the financial account details;
is reliable;
reduces the possibility of misusing the transaction details;
prevents the occurrence of fraud transactions in real-time; and
is user friendly.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A dummy card based transaction processing system for facilitating payment transactions between a plurality of users, wherein each user is associated with a dummy card having a unique dummy card number issued by a financial entity, said system comprising:
a. a plurality of user devices, each user device associated with a user having a financial account in a financial institution, the financial account being linked to a registered mobile number of the user;
b. a dummy card server configured to facilitate registration of the users by storing their personal data, dummy card number, and electronic card information into a database, and further configured to facilitate the registered users to make payment to or receive payment from other registered users by using their unique dummy card number;
c. a registration module comprising:
i. an input module configured to receive a user's personal data, dummy card number, and electronic card information, and further configured to facilitate registration of the user by storing said personal data, dummy card number, and electronic card information in the form of said lookup tables in said database, said input module further configured to generate login credentials i.e. user ID and password for said user and store the login credentials corresponding to each of said registered users in the form of a third lookup table in said database; and
ii. a profile creating module configured to create a user profile based on the received personal data,
d. a memory configured to store a pre-determined set of processing rules;
e. a login module configured to facilitate a registered user to login to the dummy card server by receiving and verifying the user's login credentials with the help of said third lookup table;
f. an updater configured to facilitate the user to update said stored information after logging into said dummy card server using said login module:
g. a linking module configured to receive information associated with at least one electronic card issued by the financial institution of the user from said registration module, and further configured to facilitate the user to link the electronic card with said unique dummy card number; and
h. an assigning module configured to facilitate the user to assign a unique number to each of said linked electronic cards,
wherein said registration module, said login module, said updater, said linking module, and said assigning module are implemented using one or more processors.

2. The system as claimed in claim 1, wherein said personal data includes user's name, biometric data, device identification indicia, and identification details.

3. The system as claimed in claim 1, wherein said database comprises:
i. a first lookup table having a list of registered users, dummy card number corresponding to each of said registered users, and registered mobile number associated with each of the registered users; and
ii. a second lookup table having a list of registered users, information relating to electronic cards of each of said registered users, and dummy card number associated with each of said registered users.

4. (canceled)

5. The system as claimed in claim 1, wherein said dummy card is a plastic card having the dummy card number in an encoded form.

6. The system as claimed in claim 1, wherein said dummy card server further includes:
a. a first communication module configured to receive a dummy card number when the dummy card associated with said dummy card number is swiped by a user at a merchant's POS terminal to initiate a payment transaction;
b. a call handling unit configured to receive an authentication call from the financial entity i.e. the dummy card issuer to authenticate the user who swiped said dummy card based on said pre-determined set of processing rules, said call handling unit comprising:
i. a crawler and extractor unit, configured to crawl through said first lookup table to extract the registered mobile number of the user based on the received dummy card number; and
ii. an authentication module configured to receive said authentication call and further configured to send a payment approval request on the extracted registered mobile number of the user, said authentication module configured to facilitate the user to enter 0 or 1 to approve or reject the payment transaction respectively,
c. a payment request generating module configured to cooperate with said authentication module to generate a payment request after the user approves the payment transaction;
d. a selection module configured to facilitate the user to enter said assigned unique number to select a card from the plurality of cards linked with the dummy card number for carrying out the payment transaction;
e. a mapping unit configured to cooperate with the payment request generating module to receive said payment request, and further configured to map said payment request with the dummy card number, said mapping unit configured to cooperate with said selection module to replace the dummy card number with the selected electronic card of the user; and
f. a second communication module configured to receive the selected electronic card, and further configured to send details of the selected electronic card to the user's financial institution for carrying out the payment transaction,
wherein said call handling unit, said payment request generating module, said selection module, and said mapping unit are implemented using one or more processors.

7. The system as claimed in claim 1, wherein said authentication module is configured to receive a login credential inputted by the user, and is further configured to authenticate said user by comparing the inputted login credential with the login credential stored in the third lookup table of said database.

8. The system as claimed in claim 7, wherein said authentication module is configured to generate and send a One Time Password (OTP) on the registered mobile number of the user, and is further configured to facilitate the user to enter the OTP to perform authentication by comparing the inputted OTP with the OTP generated and sent by the authentication module.

9. The system as claimed in claim 1, wherein said authentication module is configured to authenticate a user by facilitating the user to input his/her biometrics and comparing the inputted biometrics with the user's biometrics stored in the database.

10. A dummy card based transaction processing method for facilitating payment transactions between a plurality of users, each user defined by a unique dummy card number associated with the dummy card issued by a financial entity, said method comprising the following steps:
a. providing, a dummy card server, having a database and processing capability;
b. enabling, said dummy card server, to communicate with a plurality of user devices via a communication network, wherein each user device is associated with a user having a financial account in a financial institution, the financial account being linked to a registered mobile number of the user; and
c. enabling, said dummy card server, to register a plurality of users by receiving their personal data, dummy card number, and electronic card information and facilitate the registered users to make payment to or receive payment from other registered users by using their unique dummy card number, said step of registering further comprising the sub-steps of:
i. storing a first lookup table having a list of registered users, dummy card number corresponding to each of said registered users, and registered mobile number associated with each of the registered users; and
ii. storing a second lookup table having a list of registered users, information relating to the electronic cards of each of said registered users, and dummy card number associated with each of said registered users.

11. The method as claimed in claim 10, wherein said step of facilitating the registered users to make or receive payments comprises the following sub-steps:
a. generating, by an input module, login credentials i.e. user ID and password, for said user and storing the login credentials corresponding to each of said registered users in the form of a third lookup table in said database;
b. creating, by a profile creating module, a user profile based on the received personal data;
c. facilitating, by a login module, a registered user to login to said dummy card server0 by receiving and verifying the user's login credentials with the help of the third lookup table;
d. facilitating, by an updater, a registered user, to update said stored information after logging into said server using said login module;
e. facilitating, by a linking module, a registered user to link information of at least one card associated with the user with said unique dummy card number;
f. facilitating, by an assigning module, a registered user, to assign a unique number to each of said linked electronic cards;
g. receiving, by a first communication module, a dummy card number when the dummy card associated with said dummy card number is swiped by a user at a merchant's POS terminal to initiate a payment transaction;
h. receiving, into a call handling unit, a call from the financial entity i.e. the dummy card issuer to authenticate the user who swiped said dummy card, said step of authenticating comprising the following sub-steps:
i. extracting, by a crawler and extractor unit, the registered mobile number of the user from the second lookup table based on the user's received dummy card number; and
ii. sending, by an authentication module, a payment approval request on the extracted registered mobile number of the user upon receiving said call, and facilitating the user to enter 0 or 1 to approve or reject the payment transaction respectively,
i. generating a payment request, by a payment request generating module, after the user approves the payment transaction;
j. facilitating, by a selection module, the user to enter said assigned unique number to select a card from the plurality of cards linked with said dummy card number for carrying out the payment transaction;
k. mapping, by a mapping unit, said payment request with the dummy card number, and replacing, the dummy card number with the selected electronic card of the user; and
l. sending, by a second communication module, details of the selected electronic card to the user's financial institution for carrying out the payment transaction.

12. The method as claimed in claim 11, wherein said step of authenticating includes receiving a login credential inputted by the user, and authenticating the user by comparing the inputted login credential with the login credential stored in the third lookup table of said database .

13. The method as claimed in claim 11, wherein said step of authenticating includes generating and sending a One Time Password (OTP) on the registered mobile number of the user, and facilitating the user to enter the OTP to perform authentication by comparing the inputted OTP of the user with the OTP generated and sent by the authentication module.

14. The method as claimed in claim 11, wherein said step of authenticating includes the facilitating the user to input his/her biometrics and comparing the inputted biometrics with the user's biometrics stored in the database.
